(19) United States
(12) Patent Application Publication
(10) Pub. No.: US 2026/0302621 A1
(43) Pub. Date: Oct. 1, 2026

(54) ANTENNA PATTERN AND METHOD FOR MANUFACTURING SAME

(71) Applicant: AMOTECH CO., LTD., Namdong-gu, Incheon (KR)

(72) Inventors: Jooseung MAENG, Incheon (KR); Jinwon NOH, Incheon (KR)

(73) Assignee: AMOTECH CO., LTD., Namdong-gu, Incheon (KR)

(21) Appl. No.: 18/880,247

(22) PCT Filed: Jun. 22, 2023
(86) PCT No.: PCT/KR2023/008689

§ 371 Date: Dec. 30, 2024

(30) Foreign Application Priority Data
Jun. 28, 2022 (KR) 10-2022-0078584
Jun. 28, 2022 (KR) 10-2022-0078585

(51) Int. Cl. H01Q 7/00; H01Q 1/22; H01Q 1/38

(52) U.S. Cl. CPC H01Q 7/00; H01Q 1/22; H01Q 1/38

(57) ABSTRACT

The present disclosure relates to a loop-shaped antenna pattern mounted on a mobile terminal, etc. and used for wireless power transmission/reception or communication, and a method for manufacturing same, wherein through holes are formed in a metal sheet through a double etching process, magnetic filler is applied to the through holes to allow the line spacing (or line width) of the antenna pattern to be precisely formed, and the magnetic filler is evenly applied between the patterns, and thus shielding performance can be improved compared to a conventional antenna pattern in which a shielding sheet is disposed on the rear surface thereof.

### TECHNICAL FIELD

The present disclosure relates to a method of manufacturing an antenna pattern, and more particularly, to a method of manufacturing an antenna pattern having a loop shape, which is mounted on a portable terminal, etc. and used for wireless power transmission and reception or communication.

### BACKGROUND ART

Recently, the demand for high power wireless charging of 20 W or more for high speed charging has been increasing in the market. High output wireless charging may have degraded charging efficiency or cause a fire in severe cases because a high voltage is applied to an antenna and substrate for wireless power transmission/reception compared to a conventional charging method.

Accordingly, in the high output wireless charging market, the importance of the suppression of heat generated in addition to wireless charging efficiency is increased. The thickness of the antenna becomes thick for charging efficiency and the suppression of heat generated.

A coil winding method, a pattern printing method, and a hybrid method are basically used as a method of manufacturing an antenna for wireless power transmission/reception.

However, in a conventional manufacturing method, if the thickness of the antenna is increased, the pitch (or line width) of a pattern cannot be precisely formed. Accordingly, an antenna manufactured according to the conventional manufacturing method has a problem in that the suppression of heat generated is possible, but charging efficiency is degraded.

The contents described in the Background Art are to help the understanding of the background of the disclosure, and may include contents that are not a disclosed conventional technology.

### DISCLOSURE

### Technical Problem

The present disclosure is proposed to solve the above conventional problems, and an object of the present disclosure is to provide a method of manufacturing an antenna pattern, which enables the pitch or line width) of an antenna pattern to be precisely formed by forming a through hole in a metal sheet through a dual etching process and applying a magnetic filler to the through hole.

Furthermore, another object of the present disclosure is to provide a method of manufacturing an antenna pattern, which enables the pitch or line width) of an antenna pattern to be precisely formed by plating an inner wall surface of a through hole.

### Technical Solution

In order to achieve the objects, an antenna pattern according to a first embodiment of the present disclosure is an antenna pattern having a loop shape. A vertical cross section of the antenna pattern includes a first metal pattern, a second metal pattern separated from the first metal pattern, and a through hole interposed between the first metal pattern and the second metal pattern and configured to form a separation space between the first metal pattern and the second metal pattern. A magnetic filler is applied to the through hole.

The through hole may include a first half-hole disposed in the direction of an upper surface of the antenna pattern and a second half-hole disposed in the direction of a lower surface of the antenna pattern. The first half-hole and the second half-hole may be configured to form the through hole that vertically penetrates the antenna pattern by at least partially overlapping. The central axis of the first half-hole and the central axis of the second half-hole may be disposed on an identical line. In this case, the central axis of the first half-hole and the central axis of the second half-hole may be disposed in parallel. The width of the through hole may be 80% or more to 120% or less of the thickness of the metal pattern.

In order to achieve the objects, a method of manufacturing an antenna pattern according to a first embodiment of the present disclosure includes steps of laminating a carrier sheet to a first surface of a metal sheet, exposing a second surface of the metal sheet that faces the first surface, forming a first half-groove that is caved in the inward direction of the metal sheet from the second surface of the metal sheet by half-etching the second surface of the metal sheet, applying a magnetic filler to the first half-groove formed in the step of forming the first half-groove, laminating a coverlay sheet to the second surface of the metal sheet in which the magnetic filler has been applied to the first half-groove, removing the carrier sheet laminated to the first surface of the metal sheet, exposing the first surface of the metal sheet from which the carrier sheet has been removed, forming a second half-groove that is caved in the inward direction of the metal sheet from the first surface of the metal sheet by half-etching the first surface of the metal sheet, and applying a magnetic filler to the second half-groove formed in the step of forming the second half-groove.

In the step of forming the second half-groove, the second half-groove may be formed so that the second half-groove at least partially overlaps the first half-groove. The first half-groove and the second half-groove may form a through hole that penetrates the first surface and second surface of the metal sheet.

The through hole may form the pitch of the antenna pattern. The pitch of the antenna pattern may be identical with the thickness of the metal sheet. The width of the through hole may be 80% or more to 120% or less of the thickness of the metal sheet.

The first half-groove formed in the step of forming the first half-groove may have a first central axis that vertically penetrates the first surface and second surface of the metal sheet. The second half-groove formed in the step of forming the second half-groove may have a second central axis that vertically penetrates the first surface and second surface of the metal sheet. The first central axis and the second central axis may be separated from each other.

### Advantageous Effects

According to the present disclosure, the antenna pattern and the method of manufacturing the same have an effect in that a pitch and/or a line width can be reduced by about 50% compared to an antenna pattern formed by a conventional method of manufacturing an antenna pattern because an etching process is performed by being divided into two steps (i.e., the first half-groove forming step and the second half-groove forming step).

Furthermore, the antenna pattern and the method of manufacturing the same have an effect in that the antenna pattern having a pitch of 100 um or less can be fabricated even in a metal sheet having a thickness of 3 oz (105 um) or more because the width of a through hole (i.e., the pitch or line width of the antenna pattern) is reduced by about 50% compared to a conventional technology.

Furthermore, the antenna pattern and the method of manufacturing the same have effects in that a degree of freedom of the design is increased and a performance optimization design is possible because the antenna pattern having a pitch that is about 80% to 120% of the thickness of metal can be manufactured.

Furthermore, the antenna pattern and the method of manufacturing the same have effects in that a magnetic filler can be easily applied and the application uniformity of the magnetic filler can be improved compared to a conventional antenna pattern that is manufactured by a printing method or a coil winding method because the magnetic filler is applied to the through hole.

Furthermore, the antenna pattern and the method of manufacturing the same has an effect in that shield performance can be improved compared to a conventional antenna pattern in which a shield sheet is disposed in a rear surface thereof because the magnetic filler is applied between the patterns of the antenna pattern.

Furthermore, there is an effect in that the width of the through hole (i.e., the pitch (or line width) of the antenna pattern)) can be formed to be narrower and precise by planarizing the end of the metal pattern (i.e., the side of the antenna pattern) because the plating layer is formed at the end of the metal pattern in the antenna pattern

Furthermore, the method of manufacturing an antenna pattern can reduce the width of the through hole (i.e., the pitch or line width of the antenna pattern), which is formed in the metal sheet, by about 50% compared to a conventional method of manufacturing an antenna pattern because the through hole is formed by performing the etching process and/or the punching process by dividing the etching process and/or the punching process into two steps.

Furthermore, the method of manufacturing an antenna pattern can form the pitch (or line width) of the antenna pattern more finely and precisely because the plating layer is formed on the inner wall surface of the through hole after the through hole is formed.

Furthermore, the method of manufacturing an antenna pattern can minimize the pitch of the antenna pattern by minimizing the width of the through hole because the plating layer is formed on the inner wall surface of the through hole.

Furthermore, the method of manufacturing an antenna pattern can precisely form the pitch of the antenna pattern by planarizing the inner wall surface of the through hole because the plating layer is formed on the inner wall surface of the through hole.

### DESCRIPTION OF DRAWINGS

FIG. 1 is a diagram for describing an antenna pattern according to a first embodiment of the present disclosure and a method of manufacturing the pattern.

FIG. 2 is a diagram for describing the antenna pattern according to the first embodiment of the present disclosure.

FIG. 3 is a diagram for describing a through hole illustrated in FIG. 2.

FIG. 4 is a diagram for describing a modified example of the through hole illustrated in FIG. 2.

FIG. 5 is a flowchart for describing a method of manufacturing an antenna pattern according to the first embodiment of the present disclosure.

FIGS. 6 and 7 are diagrams for describing the steps of the method of manufacturing an antenna pattern according to the first embodiment of the present disclosure.

FIGS. 8 and 9 are diagrams for describing a comparison between a conventional method of manufacturing an antenna pattern and the method of manufacturing an antenna pattern according to the first embodiment of the present disclosure.

FIG. 10 is a diagram for describing an antenna pattern according to a second embodiment of the present disclosure.

FIGS. 11 and 12 are diagrams for describing a through hole illustrated in FIG. 10.

FIG. 13 is a diagram for describing the pitch of an antenna pattern according to the second embodiment of the present disclosure.

FIG. 14 is a flowchart for describing a method of manufacturing an antenna pattern according to the second embodiment of the present disclosure.

FIG. 15 is a diagram for describing the method of manufacturing an antenna pattern according to the second embodiment of the present disclosure.

FIGS. 16 and 17 are diagrams for describing a comparison between a conventional method of manufacturing an antenna pattern and the method of manufacturing an antenna pattern according to the second embodiment of the present disclosure.

### MODE FOR INVENTION

Hereinafter, preferred embodiments of the present disclosure are described in detail with reference to the accompanying drawings.

Embodiments are provided to more fully explain the present disclosure to a person having ordinary knowledge in the art to which the present disclosure pertains. The following embodiments may be modified in various other forms, and the scope of the present disclosure is not limited to the following embodiments. Rather, these embodiments are provided to make the present disclosure more thorough and complete and to fully convey the spirit of the present disclosure.

Terms used in this specification are used to describe a specific embodiment, and are not intended to limit the present disclosure. Furthermore, in this specification, an expression of the singular number may include an expression of the plural number unless clearly defined otherwise in the context.

In the description of the embodiments, when it is described that each layer (film), area, pattern, or structure is formed “on” or “under” each substrate, layer (film), area, pad, or pattern, this includes both expressions, including that a layer is formed on another layer “directly” or “with a third layer interposed between the two layers (indirectly)”. Furthermore, a criterion for the term “on or under of each layer” is described based on the drawings.

The drawings are merely for enabling the spirit of the present disclosure to be understood, and it should not be interpreted that the scope of the present disclosure is limited by the drawings. Furthermore, in the drawings, a relative thickness or length or a relative size may be enlarged for convenience and the clarity of description.

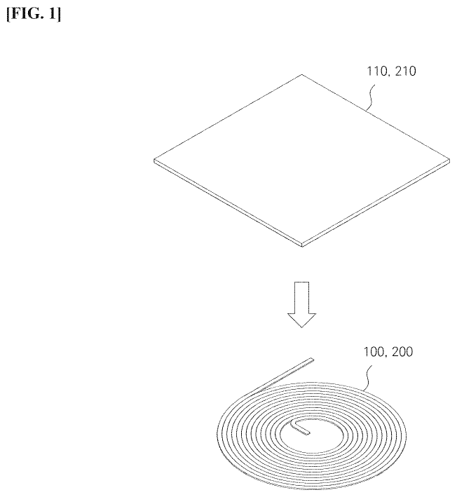

Referring to FIG. 1, in an antenna pattern and a method of manufacturing the same according to an embodiment of the present disclosure, an antenna pattern 100 having a loop shape is manufactured by using a metal sheet 110. The antenna pattern 100 manufactured through the method of manufacturing an antenna pattern may be used as an antenna pattern for wireless power consortium (WPC), an antenna pattern for near field communication (NFC), an antenna pattern for magnetic secure transmission (MST), etc., etc.

The method of manufacturing an antenna pattern according to an embodiment of the present disclosure may be used to manufacture a combo antenna pattern including two or more of WPC, NFC, and MST.

Furthermore, one or more antenna patterns 100 manufactured by the method of manufacturing an antenna pattern according to an embodiment of the present disclosure may be assembled in a circuit board (FPCB) to constitute a single antenna or a combo antenna. In this case, the antenna patterns 100 may be assembled in the FPCB through a soldering process, an ultrasonic fusion process, etc.

In this case, terminal parts for connecting at least one antenna pattern, among the NFC antenna pattern and the MST antenna pattern, and antenna patterns to an external substrate (e.g., the main substrate of a portable terminal) are formed in the FPCB. The antenna pattern 100 for WPC, which is manufactured by a method of manufacturing an antenna pattern according to a first embodiment of the present disclosure, may be assembled in the FPCB through a soldering process, an ultrasonic fusion process, etc. A combo antenna may be constituted by assembling a shield sheet, a heat dissipation sheet, etc.

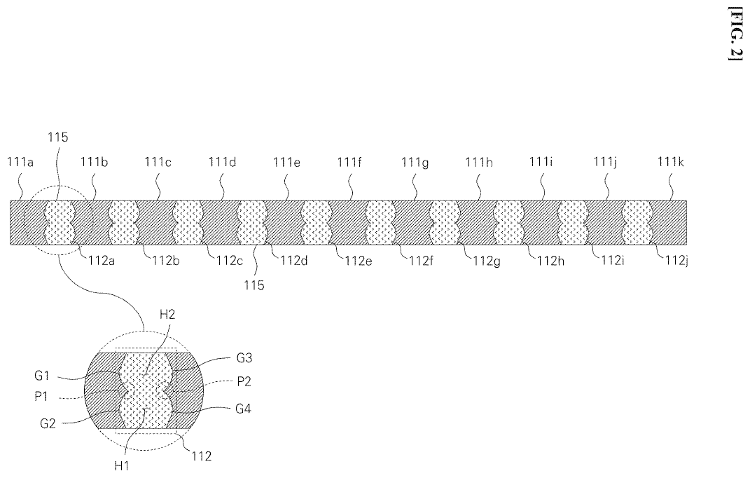

Referring to FIG. 2, in a vertical section of the antenna pattern 100 according to a first embodiment of the present disclosure, a plurality of metal patterns 111a to 111k and a plurality of through holes 112a to 112j are alternately disposed.

A plurality of concaved grooves is formed at an end of the metal pattern 111, which neighbors the through hole 112. In this case, the concaved groove may be formed only at the end of one metal pattern 111, among two metal patterns 111 that are adjacent to both sides of the through hole 112.

For example, a first end of a first metal pattern 111a may include a first concaved groove G1 formed to be inclined toward an upper part of the first metal pattern 111a and a second concaved groove G2 formed to be inclined toward a lower part of the first metal pattern 111a on the basis of the drawing.

In this case, a first protrusion P1 that is formed by connecting a first end of the first concaved groove G1 and a first end of the second concaved groove G2 is further formed at the first end of the first metal pattern 111a. In this case, the first protrusion P1 protrudes in a direction in which the first through hole 112 is disposed.

As another example, a first end of a second metal pattern 111b may include a third concaved groove G3 formed to be inclined toward an upper surface of the second metal pattern 111b and a fourth concaved groove G4 formed to be inclined toward a lower surface of the second metal pattern 111b. In this case, a second protrusion P2 that is formed by connecting a first end of the third concaved groove G3 and a first end of the fourth concaved groove G4 is further formed at the first end of the second metal pattern 111b. In this case, the second protrusion P2 protrudes in a direction in which the first through hole 112a is disposed.

In this case, the concaved grooves have been illustrated and described as being formed in both the first metal pattern 111a and the second metal pattern 111b, but the present disclosure is not limited thereto. The concaved groove may be formed in a cross section of only one of the first metal pattern 111a and the second metal pattern 111b. In this case, the through hole 112 may have a “B” shape.

The through hole 112 forms a separation space interposed between two metal patterns 111 that are adjacent to each other. The separation space formed by the through hole 112 forms the pitch of the antenna pattern 100. For example, a first through hole 112a is interposed between the first metal pattern 111a and the second metal pattern 111b and separates the first metal pattern 111a and the second metal pattern 111b. A second through hole 112b is interposed between the second metal pattern 111b and a third metal pattern 111c and separates the second metal pattern 111b and the third metal pattern 111c. Each of the third through hole 112b to a tenth through hole 112j is interposed between two metal patterns 111 that are adjacent to each other and separates the two metal patterns 111.

A magnetic filler 115 including a magnetic substance is applied to the through hole 112. The magnetic filler 115 may consist of a ferromagnetic filler, a paramagnetic filler, an anti-ferromagnetic filler, etc. In this case, the application includes that the through hole 1120 is filled with the magnetic filler 115 in addition to a dictionary meaning in which the magnetic filler 115 is applied on the inner wall of the through hole 112.

The magnetic substance has a powder form, for example, and may be made of one, among flaked powder, spherical powder, polar powder, and protrusion-shaped powder, or may be made of a material consisting of a combination of two or more powders.

The magnetic substance may be an alloy or material consisting of one element or a combination of two or more elements, among iron (Fe), nickel (Ni), cobalt (Co), manganese (Mn), aluminum (Al), zinc (Zn), copper (Cu), barium (Ba), titanium (Ti), tin (Sn), strontium (Sr), phosphorus P, boron (B), nitrogen (N), carbon (C), tungsten (W), chromium (Cr), bismuth (Bi), lithium (Li), iridium (Y), cadmium (Cd), and oxygen (O).

In the antenna pattern according to the first embodiment of the present disclosure, the magnetic filler is applied (filled) to the groove (hole) formed through etching. Accordingly, the magnetic filler can be easily applied and the application uniformity of the magnetic filler can be improved compared to a conventional antenna pattern that is manufactured by a printing method or a coil winding method.

In general, a shield sheet is disposed on a rear surface of an antenna pattern. The shield sheet prevents a magnetic field (electromagnetic waves) that is generated from the antenna pattern from affecting an electronic device.

The antenna pattern according to the first embodiment of the present disclosure has effects in that it shields even a magnetic field that is generated from the side of the pattern and increases the thickness of the shield sheet because the magnetic filler is applied between the patterns. Accordingly, shield performance can be improved compared to a conventional antenna pattern in which the shield sheet is disposed on the rear surface.

The through hole 112 includes a first half-hole H1 and a second half-hole H2 because the through hole is formed through a dual etching process as described above. In this case, the first half-hole H1 and the second half-hole H2 are constructed to at least partially overlap, thus constituting the through hole 112 that vertically penetrates an upper surface and lower surface of the antenna pattern 100. In this case, the first half-hole H1 and the second half-hole H2 correspond to a first half-groove 113 and a second half-groove 114 to be described later.

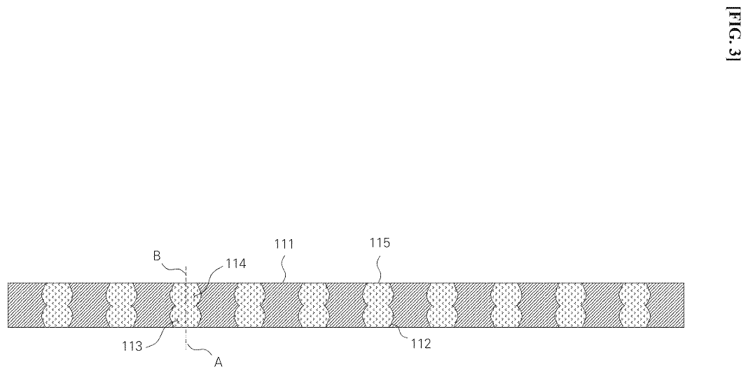

Referring to FIG. 3, a central axis A of the first half-hole H1 and a central axis B of the second half-hole H2 are orthogonal to the upper surface and lower surface of the antenna pattern 100. The central axis A and the central axis B are disposed on the same line. Accordingly, the through hole 112 has an “8” shape in which the through hole vertically penetrates the antenna pattern 100.

In the first embodiment of the present disclosure, the through hole 112 is formed through a dual etching process. It is very difficult to etch the first half-hole H1 and the second half-hole H2 so that the first half-hole H1 and the second half-hole H2 are accurately aligned in an actual process.

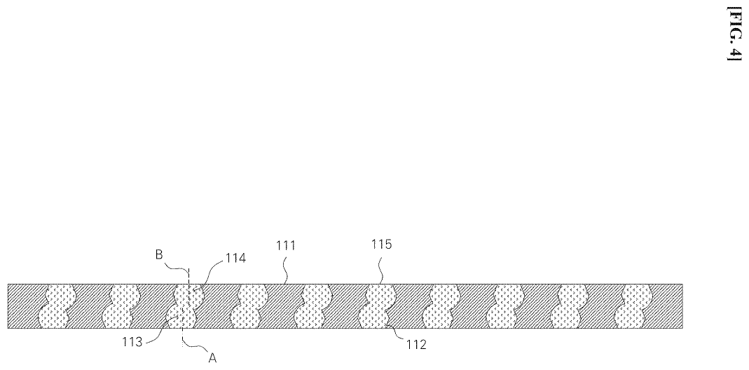

Accordingly, referring to FIG. 4, the first half-hole H1 and the second half-hole H2 are formed to be dislocated. The through hole 112 may obliquely (slantly or diagonally) penetrate the antenna pattern 100.

For example, the central axis A of the first half-hole H1 and the central axis B of the second half-hole H2 that are orthogonal to the upper surface and lower surface of the antenna pattern 100 are horizontally dislocated with respect to each other (or parallel to each other) in the drawing. The through hole 112 diagonally penetrates the antenna pattern 100. Accordingly, a cross section of the through hole 112 has an inclined “8” shape.

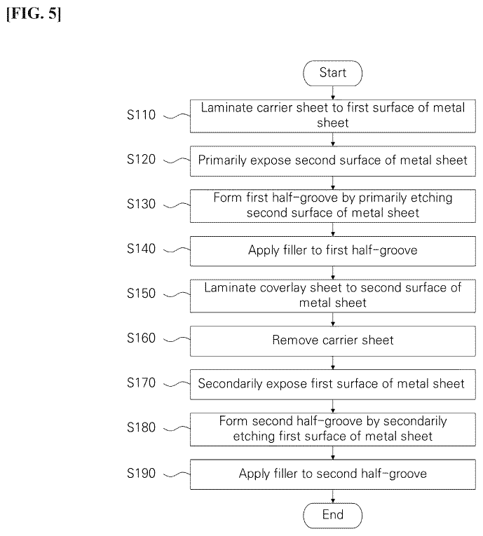

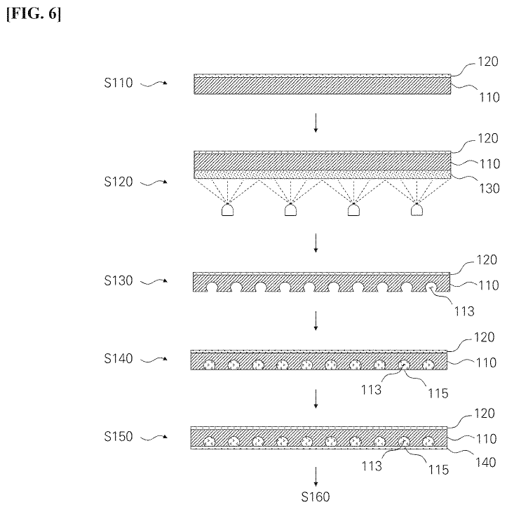

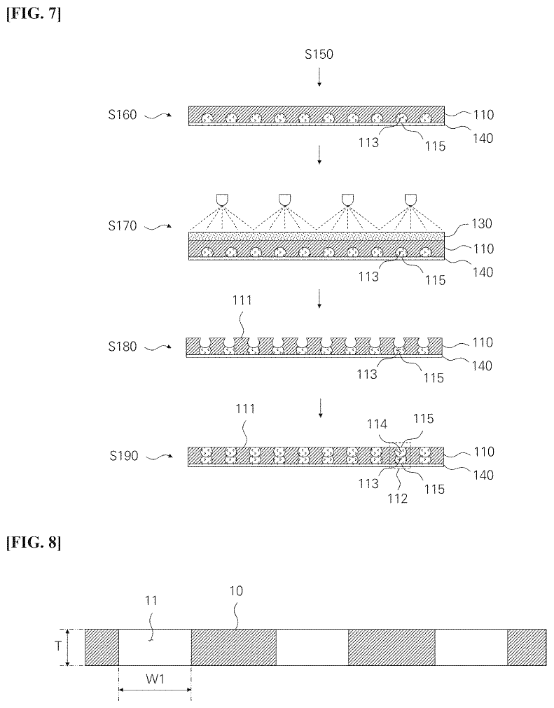

Referring to FIGS. 5 to 7, the method of manufacturing an antenna pattern according to the first embodiment of the present disclosure includes a carrier sheet laminating step S110, a primary exposure step S120, a first half-groove forming step S130, a primary filler application step S140, a coverlay sheet laminating step S150, a carrier sheet removal step S160, a secondary exposure step S170, a second half-groove forming step S180, and a secondary filler application step S190.

In the carrier sheet laminating step S110, a carrier sheet 120 is laminated to a first surface of the metal sheet 110. In the carrier sheet laminating step S110, the carrier sheet 120 is laminated to a first surface of the metal sheet 110 (i.e., an upper surface of the metal sheet 110) having a set thickness or more.

In the carrier sheet laminating step S110, the metal sheet 110 having a thickness of approximately 2 oz (i.e., approximately 70 um) or more is prepared. In this case, in the carrier sheet laminating step S110, the metal sheet 110 of a copper (Cu) material that is used in a common antenna pattern 100 is prepared.

In the carrier sheet laminating step S110, polymer, such as polyimide (PI) or polyethylene terephthalate (PET), an amorphous solid consisting of an organic compound and derivatives thereof, or resin, that is, a semi solid, is prepared as the carrier sheet 120.

In the carrier sheet laminating step S110, laminating the carrier sheet 120 to the first surface of the metal sheet 110 through a roll-to-roll process is taken as an example.

In the primary exposure step S120, a second surface of the metal sheet 110 is exposed. In the primary exposure step S120, an exposure layer 130 is formed on the second surface of the metal sheet 110.

In the primary exposure step S120, the exposure layer 130 is formed on the second surface of the metal sheet 110 by laminating a photoresist film to the metal sheet 110 to which the carrier sheet 120 has been laminated. In this case, in the primary exposure step S120, the exposure layer 130 may be formed on the second surface of the metal sheet 110 by applying a photoresist to the second surface of the metal sheet 110.

In the primary exposure step S120, UV light is radiated to the second surface of the metal sheet 110 through an exposure apparatus in the state in which the mask of the antenna pattern 100 has been stacked (or disposed) on the second surface of the metal sheet 110 on which the exposure layer 130 has been formed. Accordingly, the exposure layer 130 formed on the second surface of the metal sheet 110 is hardened in the same shape as the antenna pattern 100 of the mask of the antenna pattern 100.

In the first half-groove forming step S130, the first half-groove 113 is formed in the metal sheet 110 by etching the second surface of the metal sheet 110 that has been subjected to the primary exposure step.

In the first half-groove forming step S130, the second surface of the metal sheet 110 on which the exposure layer 130 has been formed is etched. In the first half-groove forming step S130, the second surface of the metal sheet 110 to which the photoresist film has been laminated is etched through an etching process, such as wet etching or dry etching. Accordingly, the first half-groove 113 that is caved in the inward direction of the metal sheet 110 from the second surface of the metal sheet 110 is formed in the metal sheet 110. In the first half-groove forming step S130, the exposure layer that is hardened after the first half-groove 113 is formed is removed.

In the primary filler application step S140, the magnetic filler 115 is applied to the first half-groove 113 formed through the first half-groove forming step S130. In this case, the application includes that the through hole 112 is filled with the magnetic filler 115 in addition to a dictionary meaning in which the magnetic filler 115 is applied to the inner wall of the through hole 112.

In the primary filler application step S140, applying the magnetic filler 115 including one, among a ferromagnetic filler, a paramagnetic filler, and an anti-ferromagnetic filler, or a mixture of two or more of them to the first half-groove 113 is taken as an example.

In this case, the magnetic filler 115 includes a magnetic substance having a powder form, and may be made of one, among flaked powder, spherical powder, polar powder, and protrusion-shaped powder, or may be made of a material having a combination of two or more of them. In this case, the magnetic substance may be an alloy or material consisting of one element or a combination of two or more elements, among iron (Fe), nickel (Ni), cobalt (Co), manganese (Mn), aluminum (Al), zinc (Zn), copper (Cu), barium (Ba), titanium (Ti), tin (Sn), strontium (Sr), phosphorus P, boron (B), nitrogen (N), carbon (C), tungsten (W), chromium (Cr), bismuth (Bi), lithium (Li), iridium (Y), cadmium (Cd), and oxygen (O).

In the coverlay sheet laminating step S150, a coverlay sheet 140 is laminated to the second surface of the metal sheet 110 in which the first half-groove 113 has been formed. In the coverlay sheet laminating step S150, the coverlay sheet 140 is laminated to the second surface of the metal sheet 110 in which the first half-groove 113 has been formed. In this case, the coverlay sheet 140 being a sheet that is made of a material, such as PI, PET, or thermosetting resin, is taken as an example.

In the carrier sheet removal step S160, the carrier sheet 120 is removed from the metal sheet 110 having the coverlay sheet 140 laminated to the first surface thereof. In the carrier sheet removal step S160, the carrier sheet 120 laminated to the second surface of the metal sheet 110 is removed.

In the secondary exposure step S170, the first surface of the metal sheet 110 is exposed. In the secondary exposure step S170, the exposure layer 130 is formed on the first surface of the metal sheet 110 by laminating a photoresist film to the metal sheet 110 to which the carrier sheet 120 has been laminated. In this case, in the secondary exposure step S170, the exposure layer 130 may be formed on the first surface of the metal sheet 110 by applying a photoresist to the first surface of the metal sheet 110.

In the secondary exposure step S170, UV light is radiated to the first surface of the metal sheet 110 through the exposure apparatus in the state in which the mask of the antenna pattern 100 has been stacked (or disposed) on the first surface of the metal sheet 110 on which the exposure layer 130 has been formed. Accordingly, the exposure layer 130 formed on the first surface of the metal sheet 110 is hardened in the same shape as the antenna pattern 100 of the mask of the antenna pattern 100.

In the second half-groove forming step S180, the second half-groove 114 is formed in the metal sheet 110 by etching the first surface of the metal sheet 110.

In the second half-groove forming step S180, the second half-groove 114 is formed in the metal sheet 110 by etching the first surface of the metal sheet 110 that has been subjected to the secondary exposure step.

In the second half-groove forming step S180, the first surface of the metal sheet 110 to which the photoresist film has been laminated is etched. In the second half-groove forming step S180, the first surface of the metal sheet 110 to which the photoresist film has been laminated is etched through an etching process, such as wet etching or dry etching. Accordingly, the second half-groove 114 that is caved in the inward direction of the metal sheet 110 from the first surface of the metal sheet 110 is formed in the metal sheet 110. In the second half-groove forming step S180, the exposure layer that is hardened after the second half-groove 114 is formed is removed.

In this case, in the second half-groove forming step S180, the second half-groove 114 is formed to at least partially overlap the first half-groove 113 in the first half-groove forming step S130. Accordingly, the first half-groove 113 and the second half-groove 114 form the through hole 112 that penetrates the metal sheet 110. The through hole 112 forms the pitch of the antenna pattern 100 that is formed by the metal sheet 110.

Referring to FIG. 8, in a conventional method of manufacturing an antenna pattern, a through hole 11 that forms the pitch of an antenna pattern through one etching is formed in a metal sheet 10. In this case, the width W1 of the through hole 11 is increased in proportion to the thickness T of the metal sheet 10 due to the limit of an etching technique. The width W1 of the through hole 11 (i.e., the pitch of the antenna pattern) that is formed through the conventional etching process is about twice (200%) the thickness T of the metal sheet 10.

That is, if the thickness T of the metal sheet 10 (antenna pattern) is about 2 oz (approximately 70 um), the width W1 of the through hole 11 (i.e., the pitch or line width of the antenna pattern) that is formed by the conventional method of manufacturing an antenna pattern is formed to be approximately 140 um.

If the thickness T of the metal sheet 10, the antenna pattern 100 is about 3 oz (approximately 105 um), the width W1 of the through hole 11 (i.e., the pitch or line width of the antenna pattern) that is formed by the conventional method of manufacturing an antenna pattern is formed to be approximately 210 um.

In contrast, in the method of manufacturing an antenna pattern according to the first embodiment of the present disclosure, in order to form the through hole 112, the etching process is performed by being divided into the two steps (i.e., the first half-groove forming step S130 and the second half-groove forming step S180). Accordingly, the width of the through hole 112 (i.e., the pitch or line width of the antenna pattern 100) formed in the metal sheet 110 may be formed to be the thickness or less of the metal sheet 110.

In this case, the width of the through hole 112 (i.e., the pitch or line width of the antenna pattern 100) may be formed to be about 80% to 120% of the thickness of the metal sheet 110 including an error in a manufacturing process.

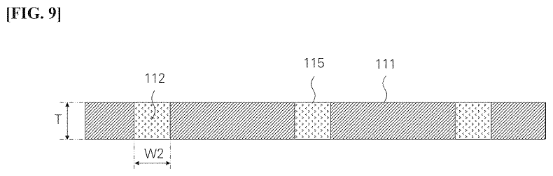

For example, referring to FIG. 9, if the thickness T of the metal sheet 110 (i.e., the antenna pattern 100) is about 2 oz (approximately 70 um), the width W2 of the through hole 112 (i.e., the pitch or line width of the antenna pattern 100) formed by the method of manufacturing an antenna pattern according to the first embodiment of the present disclosure is formed to be approximately 70 um.

If the thickness T of the metal sheet 110 (i.e., the antenna pattern 100) is about 3 oz (approximately 105 um), the width W2 of the through hole 112 (i.e., the pitch or line width of the antenna pattern 100) formed by the conventional method of manufacturing an antenna pattern is formed to be approximately 100 um.

As described above, in the method of manufacturing an antenna pattern according to the first embodiment of the present disclosure, the etching process is performed by being divided into the two steps (i.e., the first half-groove forming step S130 and the second half-groove forming step S180). Accordingly, the width of the through hole 112 (i.e., the pitch or line width of the antenna pattern 100) formed in the metal sheet 110 can be reduced by about 50% compared to the conventional method of manufacturing an antenna pattern.

Furthermore, the method of manufacturing an antenna pattern according to the first embodiment of the present disclosure has an effect in that the antenna pattern 100 having a pitch of 100 um or less can be fabricated even in the metal sheet 110 having a thickness of 3 oz (105 um) or more because the width of the through hole 112 (i.e., the pitch or line width of the antenna pattern 100) is reduced by about 50% compared to a conventional technology.

Furthermore, the method of manufacturing an antenna pattern has an effect in that a degree of freedom of the design is increased and a performance optimization design is possible because the antenna pattern 100 having a pitch that is about 80% to 120% of a thickness of metal can be fabricated.

In the secondary filler application step S190, the magnetic filler 115 is applied to the second half-groove 114 formed through the second half-groove forming step S180. In the secondary filler application step S190, the magnetic filler 115 that is the same as that in the primary filler application step S140 may be applied to the second half-groove 114. In the secondary filler application step S190, the magnetic filler 115 that is different from that in the primary filler application step S140 may be applied to the second half-groove 114.

In the method of manufacturing an antenna pattern according to the first embodiment of the present disclosure, the magnetic filler can be easily applied and the application uniformity of the magnetic filler can be improved compared to a conventional antenna pattern that is manufactured by a printing method or a coil winding method because the magnetic filler is applied to the first half-groove and the second half-groove.

Furthermore, the method of manufacturing an antenna pattern according to the first embodiment of the present disclosure can improve shield performance compared to a conventional antenna pattern in which a shield sheet is disposed on a rear surface thereof because the magnetic filler is applied between the patterns by applying the magnetic filler to the first half-groove and the second half-groove.

In this case, although not illustrated in FIGS. 5 to 7, the method of manufacturing an antenna pattern according to the first embodiment of the present disclosure may further include a surface treatment step and a stamping step that are performed by stages after the secondary filler application step S190.

In the surface treatment step, the first surface of the metal sheet 110 is subjected to surface treatment. In the surface treatment step, an anti-corrosive film is formed in the first surface of the metal sheet 110 by applying organic matter through an organic solderability preservative (OSP) process. Accordingly, the oxidation of the metal sheet 110 (i.e., the antenna pattern 100) is prevented by blocking the metal sheet 110 and the air from coming into contact with each other by planarizing the first surface of the metal sheet 110. In the surface treatment step, in order to prevent the oxidation of the metal sheet 110 along with the OSP process, a plating layer may be formed on the first surface of the metal sheet 110 by plating tin (Sn) or nickel (Ni).

In the stamping step, the outline of the antenna pattern 100 is formed in the metal sheet 110 through the stamping process. In the stamping step, the outline of the antenna pattern 100 is formed by stamping the metal sheet 110 through a stamping apparatus.

In the method of manufacturing an antenna pattern according to the first embodiment of the present disclosure, the antenna pattern 100 having a pitch of 80% or more to 120% or less of the thickness the metal sheet 110 can be manufactured through the aforementioned processes. The antenna pattern 100 manufactured through the aforementioned processes may operate as an antenna pattern for wireless power consortium (WPC), an antenna pattern for near field communication (NFC), an antenna pattern for magnetic secure transmission (MST), etc.

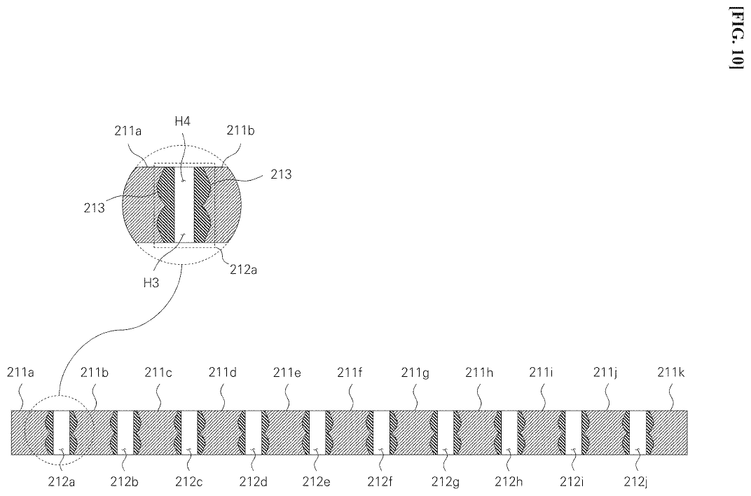

Referring to FIG. 10, in a vertical section of an antenna pattern 200 according to a second embodiment of the present disclosure, a plurality of metal patterns 211 and a plurality of through holes 212 are alternately disposed. Hereinafter, in order to easily describe the antenna pattern 200 according to the second embodiment of the present disclosure, the antenna pattern is described on the basis of the vertical section of the antenna pattern 200.

A concaved groove is formed at an end of the metal pattern 211, which neighbors the through hole 212. In this case, the concaved groove may be formed only at the end of one metal pattern 211, among two metal patterns 211 that are adjacent to each other on both sides of the through hole 212.

For example, a first concaved groove inclined toward an upper part of a first metal pattern 211a and a second concaved groove inclined toward a lower part of the first metal pattern 211a are formed at the first end of the first metal pattern 211a. In this case, a first protrusion that is formed by being connected to a first end of the first concaved groove and a first end of the second concaved groove is further formed at the first end of the first metal pattern 211a. In this case, the first protrusion protrudes in a direction in which a first through hole 212a is disposed.

The first end of the second metal pattern 211b may include a third concaved groove formed to be inclined toward an upper surface of the second metal pattern 211b and a fourth concaved groove formed to be inclined toward a lower surface of the second metal pattern 211b. In this case, a second protrusion formed by being connected to a first end of the third concaved groove and a first end of the fourth concaved groove is further formed at the first end of the second metal pattern 211b. In this case, the second protrusion protrudes in a direction in which the first through hole 212a is disposed.

In this case, the concaved grooves have been illustrated and described as being formed in both the first metal pattern 211a and the second metal pattern 211b, but the present disclosure is not limited thereto. The concaved groove may be formed in a cross section of only one of the first metal pattern 211a and the second metal pattern 211b.

A plating layer 213 is formed at an end of the metal pattern 211, which neighbors the through hole 212. The plating layer 213 is formed at the end of the metal pattern 211 through a plating process, and is formed on the concaved groove formed at the end of the metal pattern 211. The plating layer 213 may be formed to cover only the concaved groove of the metal pattern 211, and may be formed to have a multi-layer structure by repeating a plating process.

The through hole 212 is interposed between two metal patterns 211 that are adjacent to each other to form a separation space. The separation space formed by the through hole 212 forms the pitch of the antenna pattern 200.

For example, the first through hole 212a is interposed between the first metal pattern 211a and a second metal pattern 211b, and separates the first metal pattern 211a and the second metal pattern 211b. A second through hole 212b is interposed between the second metal pattern 211b and a third metal pattern 211c, and separates the second metal pattern 211b and the third metal pattern 211c. Each of the third through hole 212c to a tenth through hole 212j is also interposed between two metal patterns 211 that are adjacent to each other, and separates the two metal patterns 211.

The through hole 212 is constructed to include a first half-hole H3 and a second half-hole H4. In this case, the first half-hole H3 and the second half-hole H4 are constructed to at least partially overlap, thus constituting the through hole 212 that vertically penetrates an upper surface and lower surface of the antenna pattern 200. In this case, the first half-hole H3 and the second half-hole H4 correspond to a first half-groove 214 and a second half-groove 215 described later, respectively.

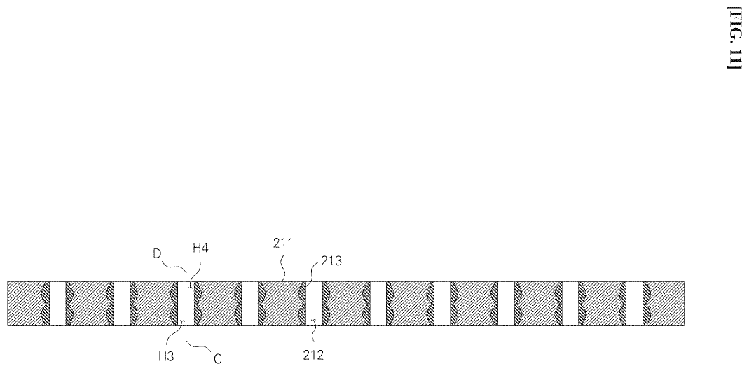

Referring to FIG. 11, a central axis C of the first half-hole H3 and a central axis D of the second half-hole H4 are orthogonal to the upper surface and lower surface of the antenna pattern 200. The central axis C and the central axis D are disposed on the same line. Accordingly, the through hole 212 has an “8” shape in which the through hole vertically penetrates the antenna pattern 200.

In the second embodiment of the present disclosure, the through hole 212 is formed through a dual etching process. It is very difficult to etch the first half-hole H3 and the second half-hole H4 so that the first half-hole and the second half-hole are accurately aligned in an actual process.

Accordingly, referring to FIG. 12, the first half-hole H3 and the second half-hole H4 are formed to be dislocated. The through hole 212 may obliquely (slantly or diagonally) penetrate the antenna pattern 200.

For example, the central axis C of the first half-hole H3 and the central axis D of the second half-hole H4 that are orthogonal to the upper surface and lower surface of the antenna pattern 200 are horizontally dislocated with respect to each other (or parallel to each other) in the drawing. The through hole 212 diagonally penetrates the antenna pattern 200. Accordingly, a cross section of the through hole 212 has an “8” shape in which the through hole has been inclined.

As the concaved groove at the end of the metal pattern 211 is planarized by being covered by the plating layer 213, the width of the through hole 212 (i.e., the pitch (or line width) of the antenna pattern 200) can be formed more narrower and precisely.

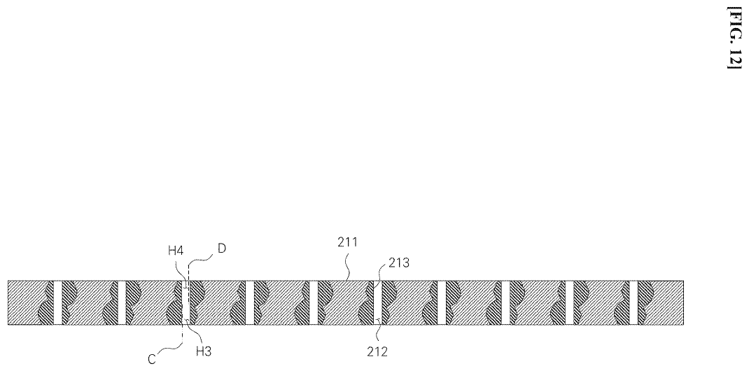

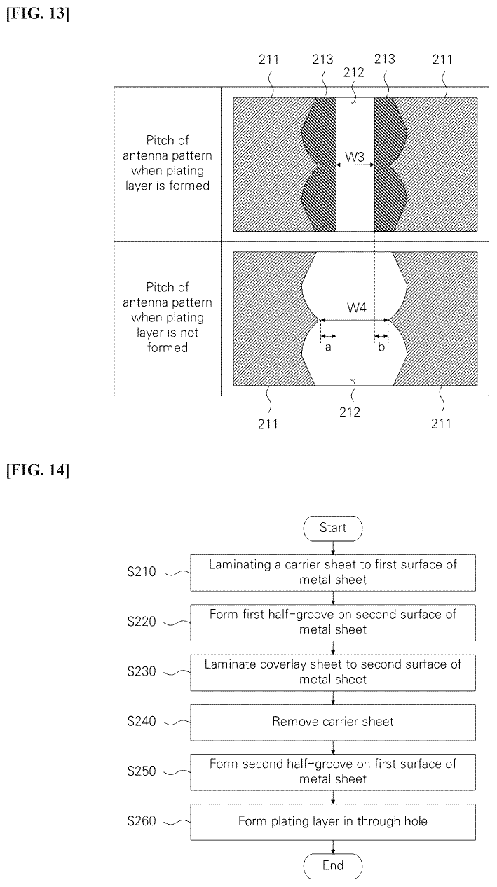

For example, referring to FIG. 13, as the plating layer 213 is formed at the end of the metal pattern 211, a width W3 of the through hole 212 is formed to be narrower than a width W4 of the metal pattern 211 in which the plating layer 213 has not been formed by a+b. Accordingly, in the antenna pattern 200 according to the second embodiment of the present disclosure, the pitch (or line width) of the antenna pattern 200 can be precisely formed although the thickness of the antenna pattern 200 (i.e., the metal sheet 210) is increased.

As described above, in the antenna pattern 200 according to the second embodiment of the present disclosure, the width of the through hole 212 (i.e., the pitch (or line width) of the antenna pattern 200) can be formed to be narrower and precise by planarizing the end of the metal pattern 211 (i.e., the side of the antenna pattern 210) because the plating layer 213 is formed at the end of the metal pattern 211.

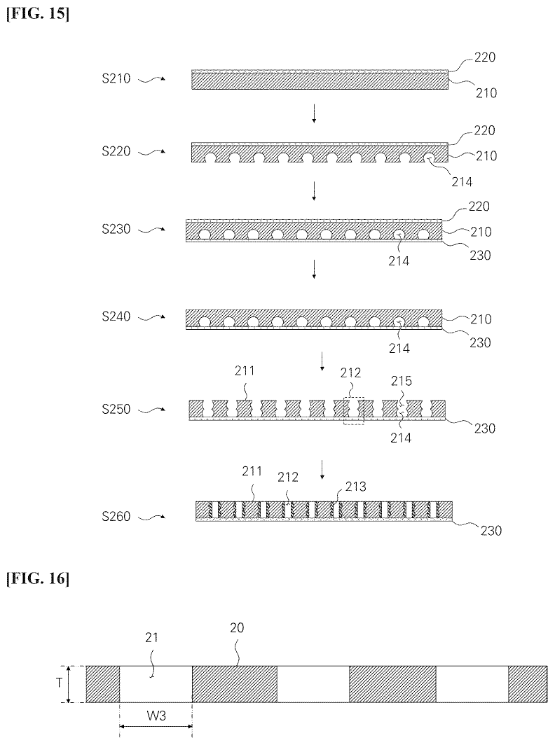

Referring to FIGS. 14 and 15, a method of manufacturing the antenna pattern according to the second embodiment of the present disclosure includes a carrier sheet laminating step S210, a first half-groove forming step S220, a coverlay sheet laminating step S230, a carrier sheet removal step S240, a second half-groove forming step S250, and a plating layer forming step S260.

In the carrier sheet laminating step S210, a carrier sheet 220 is laminated to a first surface of the metal sheet 210. In the carrier sheet laminating step S210, the carrier sheet 220 is laminated to the first surface of the metal sheet 210 (i.e., an upper surface of the metal sheet 210) having a set thickness or more.

In the carrier sheet laminating step S210, a metal sheet 210 having a thickness of approximately 2 oz (i.e., approximately 70 um) or more is prepared. In this case, in the carrier sheet laminating step S210, the metal sheet 210 of a copper (Cu) the material that is used in a common antenna pattern 200 is prepared.

In the carrier sheet laminating step S210, polymer, such as polyimide (PI) or polyethylene terephthalate (PET), an amorphous solid consisting of an organic compound and derivatives thereof, or resin, that is, a semi solid, is prepared as the carrier sheet 220.

In the carrier sheet laminating step S210, laminating the carrier sheet 220 to the first surface of the metal sheet 210 through a roll-to-roll process is taken as an example.

In the first half-groove forming step S220, the first half-groove 214 is formed in the metal sheet 210 through an etching process, a punching process, etc. In the first half-groove forming step S220, the first half-groove 214 that is caved in the inward direction of the metal sheet 210 from a second surface of the metal sheet 210 is formed.

In the first half-groove forming step S220, the first half-groove 214 may be formed on the second surface of the metal sheet 210 through the etching process.

In the first half-groove forming step S220, an exposure layer is formed on the second surface of the metal sheet 210 by exposing the second surface of the metal sheet 210.

In the first half-groove forming step S220, the exposure layer is formed by laminating a photoresist film to the metal sheet 210 to which the carrier sheet 220 has been laminated or applying a photoresist to the second surface of the metal sheet 210.

In the first half-groove forming step S220, UV light is radiated to the second surface of the metal sheet 210 through an exposure apparatus in the state in which the mask of the antenna pattern 200 has been stacked (or disposed) in the second surface of the metal sheet 210 on which the exposure layer has been formed. Accordingly, the exposure layer formed on the second surface of the metal sheet 210 is hardened in the same shape as the antenna pattern 200 of the mask of the antenna pattern 200.

In the first half-groove forming step S230, the first half-groove 214 is formed in the metal sheet 210 by etching the second surface of the metal sheet 210 that has been subjected to a primary exposure step.

In the first half-groove forming step S230, the second surface of the metal sheet 210 on which the exposure layer has been formed is etched. In the first half-groove forming step S230, the second surface of the metal sheet 210 to which the photoresist film has been laminated is etched through an etching process, such as wet etching or dry etching. Accordingly, the first half-groove 214 that is caved in the inward direction of the metal sheet 210 from the second surface of the metal sheet 210 is formed in the metal sheet 210. In the first half-groove forming step S230, the exposure layer that is hardened after the first half-groove 214 is formed is removed.

In the first half-groove forming step S220, the first half-groove 214 may be formed on the second surface of the metal sheet 210 through a punching process.

In the first half-groove forming step S220, the first half-groove 214 is formed in the second surface of the metal sheet 210 by half-punching the second surface of the metal sheet 210. In the first half-groove forming step S220, a plurality of first half-grooves 214 is formed in the second surface of the metal sheet 210 by adjusting punching pressure.

In the coverlay sheet laminating step S230, a coverlay sheet 230 is laminated to the second surface of the metal sheet 210 in which the first half-groove 214 has been formed. In the coverlay sheet laminating step S230, the coverlay sheet 230 is laminated to the second surface of the metal sheet 210 on which the first half-groove 214 has been formed. In this case, the coverlay sheet 230 being a sheet that is made of a material, such as PI, PET, or thermosetting resin, is taken as an example.

In the carrier sheet removal step S240, the carrier sheet 220 is removed from the metal sheet 210 having the coverlay sheet 230 laminated to the first surface thereof. In the carrier sheet removal step S240, the carrier sheet 220 fixed to the second surface of the metal sheet 210 is removed.

In the second half-groove forming step S250, the second half-groove 215 is formed in the metal sheet 210 through an etching process, a punching process, etc. In the second half-groove forming step S250, the second half-groove 215 that is caved in the inward direction of the metal sheet 210 from the first surface of the metal sheet 210 is formed.

In the second half-groove forming step S250, the second half-groove 215 is formed to at least partially overlap the first half-groove 214 formed in the first half-groove forming step S230. Accordingly, the first half-groove 214 and the second half-groove 215 form the through hole 212 that penetrate the metal sheet 210. The through hole 212 forms the pitch of the antenna pattern 200 that is formed by the metal sheet 210.

In the plating layer forming step S260, the plating layer 213 is formed on the inner wall surface of the through hole 212. In the plating layer forming step S260, the plating layer 213 is formed on the inner wall surface (i.e., the end of the metal sheet 210) of the through hole 212 through a plating process.

The method of manufacturing an antenna pattern according to the second embodiment of the present disclosure can minimize the pitch of the antenna pattern by minimizing the width of the through hole 212 because the plating layer 213 is formed on the inner wall surface of the through hole 212 through the plating layer forming step S260.

Furthermore, in the method of manufacturing an antenna pattern according to the second embodiment of the present disclosure, the pitch of the antenna pattern can be precisely formed by planarizing the inner wall surface of the through hole 212 because the plating layer 213 is formed on the inner wall surface of the through hole 212 through the plating layer forming step S260.

In the plating layer forming step S260, the plating layer may be formed on the inner wall surface of at least one half-groove, among the first half-groove 214 and the second half-groove 215. In the plating layer forming step S260, forming the plating layer on the inner wall surface of the half-groove that has been formed through the etching process is taken as an example.

If the first half-groove 214 and the second half-groove 215 are formed through etching in the first half-groove forming step S220 and/or the second half-groove forming step S250, a concaved groove may be formed at an end of the metal sheet 210, which neighbors the through hole 212. Accordingly, in the plating layer forming step S260, the plating layer 213 is formed on the concaved groove formed at the end of the metal sheet 210.

In the plating layer forming step S260, the plating layer 213 may be formed to cover only the concaved groove of the metal sheet 210. The plating layer 213 having a multi-layer structure may be formed by repeating a plating process.

Through the plating layer forming step S260, the through hole 212 forms a separation space that is interposed between the ends of two metal sheets 210 that are adjacent to each other. The separation space that is formed by the through hole 212 forms the pitch of the antenna pattern 200.

Referring to FIG. 16, in a conventional method of manufacturing an antenna pattern, a through hole 21 that forms the pitch of an antenna pattern is formed in a metal sheet 20 through one etching. In this case, a width W5 of the through hole 21 is increased in proportion to the thickness T of the metal sheet 20 due to the limit of an etching technique. The width W5 of the through hole 21 (i.e., the pitch of the antenna pattern) that is formed through the conventional etching process is formed to be about twice (200%) the thickness T of the metal sheet 20.

That is, if the thickness T of the metal sheet 20 (antenna pattern) is about 2 oz (approximately 70 um), the width W5 of the through hole 21 (i.e., the pitch or line width of the antenna pattern) that is formed by the conventional method of manufacturing an antenna pattern is formed to be approximately 140 um.

If the thickness T of the metal sheet 20 (antenna pattern) is about 3 oz (approximately 105 um), the width W5 of the through hole 21 (i.e., the pitch or line width of the antenna pattern) that is formed by the conventional method of manufacturing an antenna pattern is formed to be approximately 210 um.

In contrast, in the method of manufacturing an antenna pattern according to the second embodiment of the present disclosure, in order to form the through hole 212, the etching process and/or the punching process is performed by being divided into the two steps (i.e., the first half-groove forming step S230 and the second half-groove forming step S280). Accordingly, the width of the through hole 212 (i.e., the pitch or line width of the antenna pattern 200) that is formed in the metal sheet 210 may be formed to be the thickness or less of the metal sheet 210.

In this case, the width of the through hole 212 (i.e., the pitch or line width of the antenna pattern 200) may be formed to be about 80% to 120% of the thickness of the metal sheet 210 including an error in a manufacturing process.

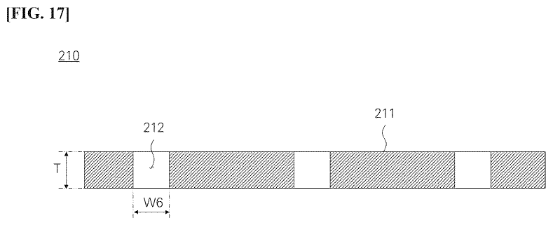

For example, referring to FIG. 17, if the thickness T of the metal sheet 210 (i.e., the antenna pattern 200) is about 2 oz (approximately 70 um), a width W6 of the through hole 212 (i.e., the pitch or line width of the antenna pattern 200) that is formed by the method of manufacturing an antenna pattern according to the second embodiment of the present disclosure is formed to be approximately 70 um.

If the thickness T of the metal sheet 210 (i.e., the antenna pattern 200) is about 3 oz (approximately 105 um), the width W6 of the through hole 212 (i.e., the pitch or line width of the antenna pattern 200) that is formed by the conventional method of manufacturing an antenna pattern is formed to be approximately 100 um.

As described above, in the method of manufacturing an antenna pattern according to the second embodiment of the present disclosure, the through hole 212 is formed by dividing the etching process and/or the punching process into the two steps (i.e., the first half-groove forming step S230 and the second half-groove forming step S250). Accordingly, the width of the through hole 212 (i.e., the pitch or line width of the antenna pattern 200) that is formed in the metal sheet 210 can be reduced by about 50% compared to the conventional method of manufacturing an antenna pattern.

Furthermore, the method of manufacturing an antenna pattern according to the second embodiment of the present disclosure has an effect in that it can manufacture the antenna pattern 200 having a pitch of 100 um or less even in the metal sheet 210 having a thickness of 3 oz (205 um) or more because the width of the through hole 212 (i.e., the pitch or line width of the antenna pattern 200) is reduced by about 50% compared to a conventional technology.

Furthermore, the method of manufacturing an antenna pattern has effects in that a degree of freedom of the design is increased and a performance optimization design is possible because the antenna pattern 200 having a pitch that is about 80% to 120% of the thickness of metal can be manufactured.

Furthermore, in the method of manufacturing an antenna pattern, the pitch (or line width) of the antenna pattern 200 can be formed more finely and precisely because the plating layer 213 is formed on the inner wall surface of the through hole 212 after the through hole 212 is formed.

In this case, although not illustrated in FIGS. 14 and 15, the method of manufacturing an antenna pattern according to the second embodiment of the present disclosure may further include the surface treatment step and the stamping step that are performed by stages after the secondary plating layer forming step S260.

In the surface treatment step, the first surface of the metal sheet 210 is subjected to surface treatment. In the surface treatment step, an anti-corrosive film is formed on the first surface of the metal sheet 210 by applying an organic matter through an organic solderability preservative (OSP) process. Accordingly, the oxidation of the metal sheet 210 (i.e., the antenna pattern 200) is prevented by blocking the metal sheet 210 and the air from coming into contact with each other while the first surface of the metal sheet 210 is planarized. In the surface treatment step, in order to prevent the oxidation of the metal sheet 210 along with the OSP process, the plating layer 213 may be formed by plating tin (Sn) or nickel (Ni) on the first surface of the metal sheet 210.

In the stamping step, the outline of the antenna pattern 200 is formed on the metal sheet 210 through the stamping process. In the stamping step, the outline of the antenna pattern 200 is formed by stamping the metal sheet 210 through a stamping apparatus.

Through the aforementioned processes, in the method of manufacturing an antenna pattern according to the second embodiment of the present disclosure, the antenna pattern 200 having a pitch that is 80% or more to 120% or less of the thickness of the metal sheet 210 can be manufactured. The antenna pattern 200 manufactured through the aforementioned processes may operate as an antenna for wireless power consortium (WPC), near field communication (NFC), magnetic secure transmission (MST), etc.

The above description is merely a description of the technical spirit of the present disclosure, and those skilled in the art may change and modify the present disclosure in various ways without departing from the essential characteristic of the present disclosure. Accordingly, the embodiments described in the present disclosure should not be construed as limiting the technical spirit of the present disclosure, but should be construed as describing the technical spirit of the present disclosure. The technical spirit of the present disclosure is not restricted by the embodiments. The range of protection of the present disclosure should be construed based on the following claims, and all of technical spirits within an equivalent range of the present disclosure should be construed as being included in the scope of rights of the present disclosure.

1. An antenna pattern having a loop shape, wherein a vertical cross section of the antenna pattern comprises:
a first metal pattern;
a second metal pattern separated from the first metal pattern; and
a through hole interposed between the first metal pattern and the second metal pattern and configured to form a separation space between the first metal pattern and the second metal pattern.

2. The antenna pattern of claim 1, wherein the through hole comprises:
a first half-hole disposed in a direction of an upper surface of the antenna pattern; and
a second half-hole disposed in a direction of a lower surface of the antenna pattern,
wherein the first half-hole and the second half-hole are configured to form the through hole that vertically penetrates the antenna pattern by at least partially overlapping.

3. The antenna pattern of claim 2, wherein a central axis of the first half-hole and a central axis of the second half-hole are disposed on an identical line.

4. The antenna pattern of claim 2, wherein a central axis of the first half-hole and a central axis of the second half-hole are disposed in parallel.

5. The antenna pattern of claim 1, wherein a width of the through hole is 80% or more to 120% or less of a thickness of the metal pattern.

6. The antenna pattern of claim 1, wherein a magnetic filler is applied to the through hole.

7. The antenna pattern of claim 1, further comprising a plating layer formed on an inner wall surface of the through hole.

8. The antenna pattern of claim 7, wherein the plating layer is formed at least one end, among a first end of the first metal pattern that faces the second metal pattern and a first end of the second metal pattern that faces the first metal pattern.

9. The antenna pattern of claim 7, wherein:
a concaved groove is formed at least one end, among a first end of the first metal pattern that faces the second metal pattern and a first end of the second metal pattern that faces the first metal pattern, and
the plating layer is plated on the concaved groove and configured to planarize at least one first end, among the first end of the first metal pattern and the first end of the second metal pattern.

10. A method of manufacturing an antenna pattern, the method comprising steps of:
laminating a carrier sheet to a first surface of a metal sheet;
forming a first half-groove on a second surface of the metal sheet;
laminating a coverlay sheet to the second surface of the metal sheet;
removing the carrier sheet laminated to the first surface of the metal sheet; and
forming a second half-groove on the first surface of the metal sheet.

11. The method of claim 10, wherein the step of forming the first half-groove comprises steps of:
exposing the second surface of the metal sheet that faces the first surface;
forming the first half-groove that is caved in an inward direction of the metal sheet from the second surface of the metal sheet by half-etching the second surface of the metal sheet; and
applying a magnetic filler to the first half-groove formed in the step of forming the first half-groove,
wherein the step of forming the second half-groove comprises steps of:
exposing the first surface of the metal sheet from which the carrier sheet has been removed;
forming the second half-groove that is caved in the inward direction of the metal sheet from the first surface of the metal sheet by half-etching the first surface of the metal sheet; and
applying a magnetic filler to the second half-groove formed in the step of forming the second half-groove.

12. The method of claim 10, wherein:
in the step of forming the second half-groove, the second half-groove is formed so that the second half-groove at least partially overlaps the first half-groove, and
the first half-groove and the second half-groove form a through hole that penetrates the first surface and second surface of the metal sheet.

13. The method of claim 12, wherein:
the through hole forms a pitch of the antenna pattern, and
the pitch of the antenna pattern is identical with a thickness of the metal sheet.

14. The method of claim 12, wherein a width of the through hole is 80% or more to 120% or less of a thickness of the metal sheet.

15. The method of claim 10, wherein:
the first half-groove formed in the step of forming the first half-groove has a first central axis that vertically penetrates the first surface and second surface of the metal sheet,
the second half-groove formed in the step of forming the second half-groove has a second central axis that vertically penetrates the first surface and second surface of the metal sheet, and
the first central axis and the second central axis are separated from each other.

16. The method of claim 10, wherein:
the first half-groove formed in the step of forming the first half-groove has a first central axis that vertically penetrates the first surface and second surface of the metal sheet,
the second half-groove formed in the step of forming the second half-groove has a second central axis that vertically penetrates the first surface and second surface of the metal sheet, and
the first central axis and the second central axis are disposed on an identical line.

17. The method of claim 10, further comprising a step of forming a plating layer on an inner wall surface of at least one of the first half-groove and the second half-groove.

18. The method of claim 17, wherein:
the first half-groove and the second half-groove form a through hole that penetrate the first surface and second surface of the metal sheet, and
in the step of forming the plating layer, an inner wall surface of the through hole is planarized by forming a plating layer on the inner wall surface of at least one of the first half-groove and the second half-groove.

19. The method of claim 17, wherein:
the first half-groove and the second half-groove form a through hole that penetrates the first surface and second surface of the metal sheet, and
in the step of forming the plating layer, the plating layer is formed on an inner wall surface of the through hole.

20. The method of claim 10, wherein:
in the step of forming the first half-groove, the first half-groove that is caved in an inward direction of the metal sheet from the second surface of the metal sheet is formed through a half etching and a punching process, and
in the step of forming the second half-groove, the second half-groove that is caved in the inward direction of the metal sheet from the first surface of the metal sheet is formed through a half etching and a punching process.
